(19) United States
(12) Patent Application Publication
(10) Pub. No.: US 2021/0390137 A1
(43) Pub. Date: Dec. 16, 2021

(54) TECHNIQUES FOR DETERMINING MACHINE OPERATION USING AUDIO

(71) Applicant: Enel X North America, Inc., Boston, MA (US)

(72) Inventor: Daniel Feldman, San Jose, CA (US)

(21) Appl. No.: 17/342,140

(22) Filed: Jun. 8, 2021

Related U.S. Application Data
(60) Provisional application No. 63/037,395, filed on Jun. 10, 2020.

(51) Int. Cl. G06F 16/68; G06N 20/00; B60L 53/66

(52) U.S. Cl. CPC G06F 16/686; G07C 5/085; B60L 53/665; G06N 20/00

(57) ABSTRACT

Techniques for determining machine operation using audio are disclosed. For example, a machine may be registered in a database and first audio data of the machine representing sound made by the machine during an operation may be received. A first digital signature associated with operation of the machine may be determined using the audio data. Instructional data may be received to correlate the first digital signature with the registered machine. Later, second audio data representing sound present in an environment of the machine may be obtained, and a status of the machine may be determined by comparing a second digital signature generated using the second audio data and the first digital signature. The status may indicate one of a normal operation of the machine or that operation of the machine is indeterminable. A notification including the status may be transmitted to a user device.

### RELATED APPLICATIONS

The present application claims the benefit of priority under 35 U.S.C. § 119(e) of U.S. Provisional Patent Application No. 63/037,395, entitled TECHNIQUES FOR DETERMINING MACHINE OPERATION USING AUDIO, filed Jun. 10, 2020, which is hereby incorporated by reference in its entirety.

### TECHNICAL FIELD

The present disclosure generally relates to determining machine operation. More particularly, techniques for determining machine operation using audio are disclosed.

### BRIEF DESCRIPTION OF THE DRAWINGS

The present embodiments will become more fully apparent from the following description, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 shows a system for determining machine operation according to some embodiments.

FIG. 2 shows a relational diagram illustrating the association of a machine operation sound to a machine identity according to some embodiments.

FIG. 3 shows a process for training a device to detect machine operation from sound according to some embodiments.

FIG. 4 shows a process for detecting machine operation from sound according to some embodiments.

FIG. 5 illustrates a system in accordance with an embodiment of the disclosure.

FIG. 6 illustrates a system in accordance with an embodiment of the disclosure.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Moreover, the phrases “connected to” and “coupled to” are used herein in their ordinary sense, and are broad enough to refer to any suitable coupling or other form of interaction between two or more entities, including mechanical, fluid, and thermal interaction. Two components may be coupled to each other even though they are not in direct contact with each other. The phrase “attached to” refers to interaction between two or more entities which are in direct contact with each other and/or are separated from each other only by a fastener of any suitable variety (e.g., an adhesive, etc.).

The term “opposite” is a relational term used herein to refer to a placement of a particular feature or component in a position corresponding to another related feature or component wherein the corresponding features or components are positionally juxtaposed to each other. By way of example, a person's right hand is opposite the person's left hand.

The terms “a” and “an” can be described as one, but not limited to one. For example, although the disclosure may recite an element having, e.g., “a line of stitches,” the disclosure also contemplates that the element can have two or more lines of stitches.

Unless otherwise stated, all ranges include both endpoints and all numbers between the endpoints.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment. Not every embodiment is shown in the accompanying illustrations, however, at least a preferred embodiment is shown. At least some of the features described for a shown preferred embodiment are present in other embodiments.

The term electric vehicle (EV), as used herein, refers to a motorized vehicle deriving locomotive power, either full-time or part-time, from an electric system on board the motorized vehicle. By way of non-limiting examples, an EV may be an electrically powered passenger vehicle for road use; an electric scooter; an electric fork lift; a cargo-carrying vehicle powered, full-time or part-time, by electricity; an off-road electrically powered vehicle; an electrically powered watercraft, etc.

The term electric vehicle supply equipment (EVSE), as used herein, refers to equipment by which an EV may be charged or recharged. An EVSE may comprise or be coupled to a computing system whereby service to the EV is provisioned, optionally, according to operator-selectable parameters. An EVSE may comprise a means of providing cost accounting, and may further comprise a payment acceptance component. An EVSE may be installed at a home of an owner/operator of an EV, at a place of business for an owner/operator of an EV, at a fleet facility for a fleet comprising one or more EVs, at a public charging station, etc.

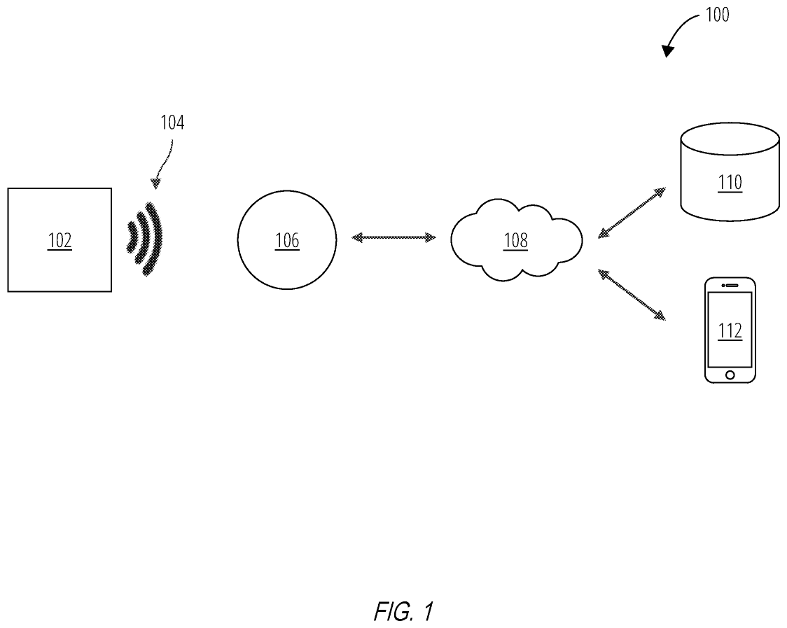

FIG. 1 shows a system 100 for determining machine operation according to some embodiments. In some embodiments, the system 100 is trained to recognize normal operation of one or more machines using audio of the sound each machine makes during normal operation. For instance, the system 100 is first trained by receiving audio of the sound a machine makes during normal operation and an input specifying that the received sound is the sound made by the machine during normal operation. Training may be performed using one or a plurality of audio samples of the machine sound. After training, the system 100 may be used to identify when the machine is operating normally (e.g., the machine is making sounds during operation consistent with the trained normal operation sounds). The system 100 may also identify when it cannot determine the machine is operating normally (e.g., the machine is making sounds during operation that are inconsistent with the trained normal operation sounds, or the machine is not making sound). When the system 100 cannot determine the machine is operating normally, this may be indicative of malfunctioning by the machine. One or more notifications may be transmitted to a user device indicating that the machine is operating normally and, based on an anticipated delivery of such notification(s), a user can be apprised that the machine is operating normally whether or not in physical presence with the machine during operation. As a corollary, an absence of anticipated delivery of such notification(s) to the user device may apprise the user that the machine may not be operating normally, thereby also apprising the user of an operational status of the machine. In other embodiments, notifications may be transmitted to a user device indicating that the system cannot determine normal operation of the machine and delivery of such notifications can apprise the user that the machine may not be operating normally, thereby also apprising the user of an operation status of the machine. The elements of the system 100 are explained below.

The system 100 includes a machine 102. In some embodiments, one or more machines 102 are included in the system 100. The machine 102 may be any machine (e.g., electronic, mechanical, or electro-mechanical). In some embodiments, the machine 102 is a home appliance. For example, the machine 102 may be a washing machine, a dish washer, a coffee maker, a refrigerator and/or a freezer, a water heater, or a heating and/or cooling system (e.g., an air conditioning unit, a heater, etc.).

In some embodiments, the machine 102 makes a sound 104 during operation. For example, the sound 104 can be the sound made by the machine 102 during normal operation. For example, when the machine 102 is a washing machine, the sound 104 may be a sound made by the washing machine when it is in use washing clothes and functioning normally. For example, when the machine 102 is an air conditioning unit, the sound 104 may be a sound made by the unit when it is cooling air and functioning normally. In some embodiments, the sound 104 is a normal, functioning sound that the machine 102 makes during normal operation, where the sound has one or more of a particular pitch, loudness, dynamic, timbre, and duration. When the machine 102 malfunctions, however, the sound 104 may be a different sound to a sound made during normal operation, and may have one or more of a different pitch, loudness, dynamic, timbre, and duration, for example. In other cases, when the machine malfunctions, the sound 104 may cease altogether.

The system 100 includes a capture device 106 that captures audio. In some embodiments, one or more capture devices 106 are included in the system 100. In some embodiments, the capture device 106 is a computing device (e.g., mobile phone, tablet computer, laptop computer, desktop computer, etc.) configured to record audio. For example, the capture device 106 may include one or more microphones or sound sensors for recording sound. In some embodiments, the capture device 106 is a network-connected thermostat. In some embodiments, the capture device 106 is an EVSE. For example, the EVSE may be located in a user's garage where one or more machines 102 are located, and where the machine 102 may be an appliance such as a washing machine or dryer. In some embodiments, the capture device 106 is a network connected speaker having one or more microphones, a network connected camera having one or more microphones, a remote control having one or more microphones, a television having one or more microphones, or some other appliance having one or more microphones. For example, any device (e.g., a device found at home) that is used for voice control and normally adjacent to the machine 102 being monitored can be used for recording.

In some embodiments, the capture device 106 receives or acquires the sound 104 made by the machine 102. For example, the capture device 106 may use one or more microphones to record the sound 104 as audio data and save it to local memory of the capture device 106. Alternatively or in addition, audio data representing the sound 104 may be saved to one or more servers 110 (e.g., to one or more a databases of the one or more servers 110) which are communicatively coupled to the capture device 106 via a network 108. In some embodiments, the capture device 106 periodically receives or acquires the sound 104 (e.g., every minute, every hour, every day, etc.) in this manner.

In some embodiments, the capture device 106 is trained using the sound 104 to recognize normal operation of the machine 102. In some embodiments, machine learning using convolutional neural network(s) (CNN) and/or recursive neural network(s) (RNN) is used to perform the training. In some embodiments, alternatively or in addition, the training generates a digital signature corresponding to the sound 104. The signature is stored in local memory of the capture device 106 or in remote memory (e.g., a database of the one or more servers 110). In some embodiments, the signature is stored in a catalog of digital signatures corresponding to different machines, where the catalog is stored in memory of one or both of the capture device 106 and the one or more servers 110. In some embodiments, during training, the capture device 106 also receives an input that identifies the machine from which the sound 104 is obtained. For example, the input may be a voice command (e.g., a user speaks “remember that this is the sound of the washing machine”). The voice command may be input directly to the capture device 106 or transmitted to the capture device 106 via another device, such as a smart home assistant (e.g., an Alexa® device or a Google Home® device). Alternatively, or in addition, the command may be input into the capture device 106 via a user interface (e.g., touch screen, display, etc.) or via a keyboard or other device. In some embodiments, the one or more machines 102 may be input via a user device 112 (discussed further below) into an application or platform (e.g., cloud platform) enabled and operated by, for example, the one or more servers 110 and associated with the capture device 106, creating a list of the machines 102. Digital signature(s) of each machine 102, as well as detected sound and command inputs associated with each machine 102, may be organized such that they are linked to the relevant machine of the list.

After training, the capture device 106 may be used to record future sounds made by the machine 102 and determine whether the machine 102 is operating normally. In some embodiments, the capture device 106 receives sound, determines a digital signature associated with the sound, and compares the digital signature to one or more stored digital signatures. In some embodiments, if there is a match between compared signatures, the capture device 106 determines one or more of: (1) an identity of a machine 102 making the sound and (2) whether the machine 102 is operating normally. For example, if there is a match between compared signatures, the capture device 106 may determine the identity of the machine 102 and that the machine 102 is operating normally, and may transmit a notification via the network 108 to the user device 112 reporting normal operation. In some embodiments, if there is not a match between compared signatures, the capture device 106 determines that it cannot identify the machine 102 and/or that it cannot determine whether the machine 102 is operating normally. Here, the capture device 106 may transmit a notification via the network 108 to the user device 112 reporting unsuccessful normal operation determination for one or more machines 102. In some embodiments, it may be advantageous for the capture device 106 to both perform the training for the machine 102 and thereafter record the sound of the machine 102 for operation determination. This may increase the likelihood of proper identification of the machine 102 and properly determining what is background noise.

In some embodiments, notifications may be requested by a user or otherwise delivered to a user. For example, a user may request (e.g., via the user device 112 or another device that communicates with the capture device 106 and/or the one or more servers 110) (e.g., via a voice command or manually input command) that the user device 112 receives notifications based on machine operation. For example, when the capture device 106 is configured to receive operation sound from a machine 102 that is a washing machine, a user may request “send me a notification when my clothes are done washing.” Here, the capture device 106 may receive operation sound at various points in time (e.g., periodically) and determine whether the machine 102 is operating normally. Once the capture device 106 determines that it cannot identify the machine 102 and/or it cannot determine whether the machine 102 is operating normally (e.g., because no operation sound is received due to completed machine function, or because there is an error in machine operation), the capture device 106 may transmit a notification to the user device 112, which may indicate washing is complete by the washing machine (the machine 102).

It should be noted that in some embodiments, the one or more servers 110 may perform all or a subset of the activities discussed regarding the capture device 106. For example, the one or more servers 110 may receive recorded audio (e.g. audio data) from the capture device 106 or record audio itself, perform training using the recorded audio, analyze future received audio to determine machine operation and/or identify machine(s), and transmit notification(s) to the user device 112.

The network 108 facilitates communication between one or more of the capture device 106, the one or more servers 110, and the user device 112. In some embodiments, the network 108 is one or a combination of the Internet, a cellular network, a wide area network (WAN), a local area network (LAN), a wired network, a wireless network, and the like. In some embodiments, the one or more servers 110 have memory configured to store data (e.g., audio data from the capture device 106) and a processor configured to perform processing (e.g., using audio data from the capture device 106). In some embodiments, the user device 112 is a mobile phone, tablet computer, laptop computer, desktop computer, or the like.

Note that while the system 100 of FIG. 1 illustrates a single machine 102, it is contemplated that embodiments of a system like that of the system 100 could include a capture device 106 and/or one or more servers 110 that are trained for, subsequently capture/record future sounds made by, and/or send notifications regarding a plurality of machines in a manner consistent with description herein. Further note that while the system 100 of FIG. 1 illustrates a single user device 112, it is contemplated that embodiments of a system like that of the system 100 could communicate with multiple such user devices (of the same or different users).

Note also that while the system 100 of FIG. 1 illustrates a single capture device 106, it is contemplated that in some embodiments of such systems, multiple such capture devices could function with the one or more servers 110 consistent with disclosure herein. These multiple capture devices could be placed in different locations, and/or may monitor different machines like the machine 102.

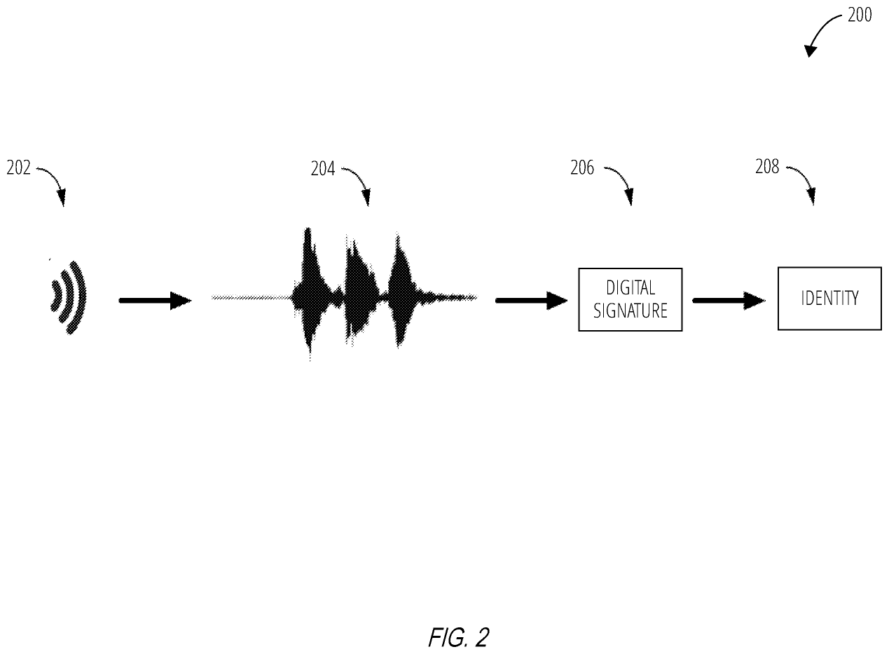

FIG. 2 is a relational diagram 200 illustrating the association of a machine operation sound 202 with a machine identity 208 according to some embodiments. In some embodiments, the machine operation sound 202 (e.g., the sound 104 of FIG. 1) is received (e.g., by the capture device 106 of FIG. 1). For example, the machine operation sound 202 may be sound of a machine functioning normally. In some embodiments, the machine operation sound 202 is recorded as an electronic waveform 204 representing the sound 202. The waveform 204 may be an example of audio data representing the sound 202. The waveform 204 may be different (e.g., have different amplitudes, duration, etc.) depending on the particular machine from which the sound 202 is generated. For example, the waveform 204 for a washing machine is different to the waveform 204 of a coffee maker.

In some embodiments, the waveform 204 is processed to convert it into a digital signature 206. In some embodiments, the digital signature 206 is data reflecting the waveform 204 that is comparable to other digital signatures. For example, the digital signature 206 may be a combination of unique letters and/or numbers corresponding to the waveform 204 that is generated by processing the waveform 204. In some embodiments, it is determined that the digital signature 206 corresponds to a particular machine identity 208 that indicates the machine from which the machine operation sound 202 was generated. In some embodiments, the machine identity 208 is linked to the digital signature 206 by an input specifying the linkage. For example, a user may enter (e.g., via voice input or non-voice input) a list of machines to an application or portal associated with the capture device 106. The user may then specify (e.g., via a voice or non-voice command, using the capture device 106) that the sound 202 is generated by a particular machine (e.g., as in the machine 102 of FIG. 1) of the list. For example, regarding the sound 202, the user may speak “remember that this is the sound of the washing machine” to one or more of the capture device 106, the device 112, or some other device connected to the capture device 106. One or more of the capture device 106 and the server 110 may then link the sound 202 with an identity 208 of the list associated with “washing machine.”

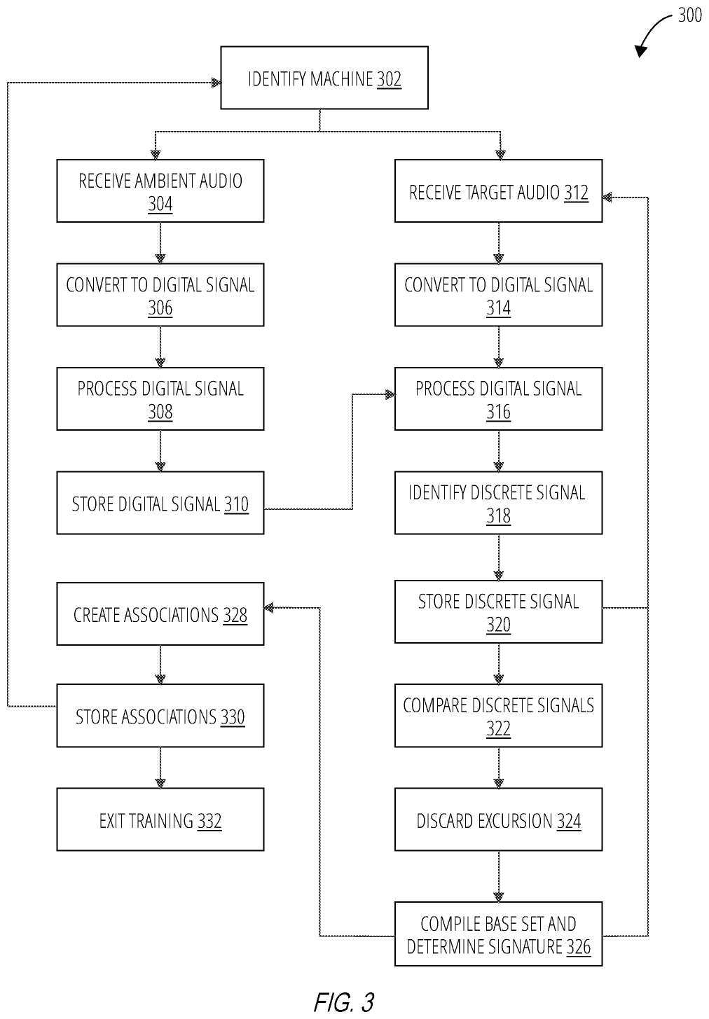

FIG. 3 is a process 300 for training a computing device (e.g., the capture device 106) to detect machine operation from sound according to some embodiments. The blocks of the process 300 may occur in the order shown in FIG. 3 or in a different order, and blocks may occur in parallel or sequentially.

At a block 302, a machine whose sound is to be used for training is identified. In some embodiments, the machine can be identified via a voice command (e.g., via voice recognition or the like) provided to the computing device that identifies the machine (e.g., “the noise you hear is the washing machine”). In some embodiments, the identification is received via a user interface (e.g., a touch panel display, a keyboard, etc.) of the computing device. In some embodiments, the identification includes registration information including one or more of colloquial or formal machine name, information on the type of machine, and/or machine serial or stock number.

At a block 304, the computing device receives (e.g., passively or actively; e.g., obtains, or acquires) ambient audio from the environment in which it is located. In some embodiments, the ambient audio is received by one or more microphones or sound sensors. At a block 306, the ambient audio is converted to a digital signal (e.g., a data signal) and at a block 308 the digital signal is processed. In some embodiments, the processing includes one or more of applying one or more filters to the digital signal, compressing the digital signal, and analyzing the digital signal to establish a digital signal for ambient noise of the environment in which the computing device is located. At a block 310, the digital signal is stored in local and/or remote memory of the computing device.

At a block 312, the computing device receives (e.g., passively or actively; e.g., obtains, or acquires) target audio (e.g., the sound 104 of FIG. 1) of the identified machine. In some embodiments, the target audio is audio of machine operation by the identified machine. In some embodiments, the target audio is a capture or recording that reflects or represents sound made by the identified machine during operation of the machine. At a block 314, the target audio is converted to a digital signal and at a block 316, the digital signal is processed. In some embodiments, the processing includes one or more of applying one or more filters to the digital signal, compressing the digital signal, and analyzing the digital signal. In some embodiments, the processing at the block 312 includes removing (e.g., filtering) ambient audio of the environment from the target audio. In some embodiments, the removing includes subtracting the digital signal of the ambient audio (e.g., stored at the block 310) from the target audio digital signal to create a discrete signal of the target audio at a block 318, where the discrete signal is a signal representing the target audio with ambient audio removed.

At a block 320, the discrete signal is stored (e.g., in local storage of the capture device 106 or a remote storage system such as at the one or more servers 110). In some embodiments, the discrete signal is stored as part of an initial set of discrete signals preparatory to identifying a base set of discrete signals. A base set of discrete signals is a set of one or more discrete signals that can be compared to identify a unique digital signature and/or digital signature envelope for the identified machine. In some embodiments, the base set is a plurality of discrete signals. In some embodiments, more discrete signals in a base set results in more accurate training for a machine.

The computing device determines whether an initial set has been acquired by counting the number of discrete signals for a particular identified machine that have been stored. When the computing device determines that an initial set of discrete signals has not been acquired (e.g., the number of discrete signals stored at a block 320 for a particular machine is below a threshold representing the number of discrete signals that is to be used in a base set of discrete signals), the process 300 may return to the block 312 and receive more target audio for the identified machine. When the computing device determines that an initial set of discrete signals has been acquired (e.g., the number of discrete signals stored at the block 320 is equal to or greater than the threshold representing the number of discrete signals that is to be used in a base set of discrete signals), process 300 may continue to a block 322.

At the block 322, the computing device may compare the discrete signals of the initial set to determine if any unacceptable excursions exist. An excursion exists when a discrete signal in the initial set varies significantly (e.g., greater than a threshold range) at one or more locations in its signal from one or more of the other discrete signals in the initial set, such that a digital signature or digital signature envelope cannot be established using the discrete signals of the initial set. At a block 324, one or more excursions may be discarded. In some embodiments, the computing device determines if an initial set still exists after discarding of an excursion(s). In some embodiments, if the number of discrete signals within the initial set after any discarding of excursion(s) is greater than or equal to the threshold representing the number of discrete signals that is to be used in a base set of discrete signals, the initial set still exists. The computing device accordingly determines that the discrete signals of the initial set are a base set. In some embodiments, the initial set does not exist if after discarding excursion(s) the number of discrete signals in the initial set is below the threshold representing the number of discrete signals that is to be used in a base set of discrete signals. If the initial set does not exist and compiling cannot take place (because there is as of yet no base set), the process 300 returns to block 312 to acquire more target audio (and discrete signal(s)) to further populate the initial set. The blocks 312 through 324 may be repeated until a base set of discrete signals is acquired.

At a block 326, the base set of discrete signals is compiled. Also, at the block 326, when the base set is compiled, the discrete signals of the compiled base set are combined to generate a digital signature and/or digital signature envelope for the identified machine.

At a block 328, the computing device associates or links or correlates the generated digital signature (or the received target audio) with the identified machine. The association is stored (at the block 330) in local memory of the computing device and/or remote memory such that the identified machine is linked to the generated digital signature. In some embodiments, instructional data is received or obtained that is used to correlate, link, or associate the generated digital signature (or the received target audio) with the identified and/or registered machine. In some embodiments, the instructional data indicates that the digital signature and/or target audio reflects operation (e.g., normal operation) of the machine. In some embodiments, the instructional data is voice command data (e.g., provided using voice recognition or the like) that identifies the machine and operation of the machine (e.g., “the noise you hear is the washing machine”). In some embodiments, the identification is received via a user interface (e.g., a touch panel display, a keyboard, etc.) of the computing device.

The process 300 may then return to the block 302 to identify another machine and train the computing device for sound of the other machine. Alternatively, training may end at the block 332.

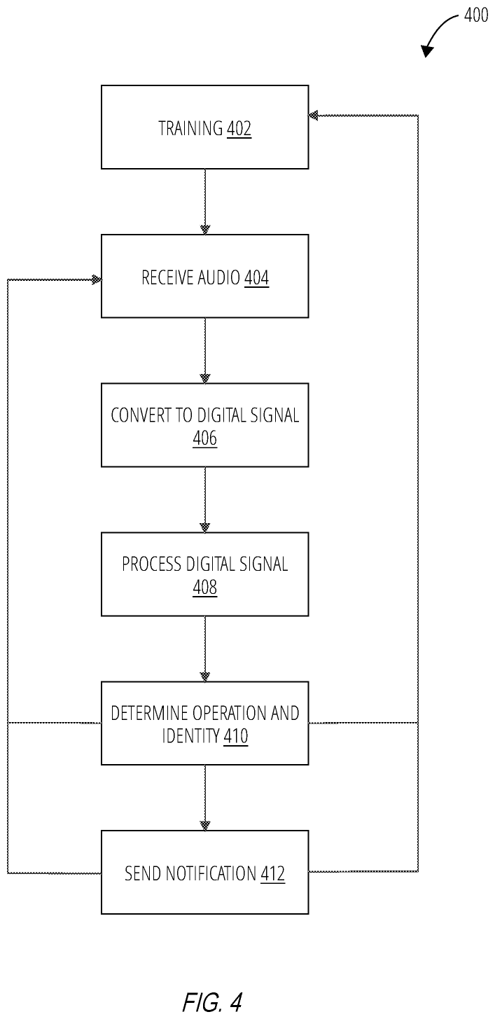

FIG. 4 shows a process 400 for detecting machine operation from sound according to some embodiments. At a block 402, training is performed (e.g., by the capture device 106 and/or the one or more servers 110 of FIG. 1) such that operation of a machine (e.g., the machine 102 of FIG. 1) can be determined using sound the machine makes during operation. In some embodiments, the training includes the training process 300 outlined in FIG. 3.

At block 404, audio or sound is received (e.g., passively or actively; e.g., obtained, or acquired) (e.g., by capture device 106 and/or the one or more servers 110) from an environment of the machine. In some embodiments, the audio or sound is received via one or more microphones of capture device 106. In some embodiments, the audio or sound captured includes sound made by a machine during operation of the machine. For example, the audio may include the sound a home appliance makes during operation. Further, the audio or sound may (also) include any background noise present in the environment of the machine. In some embodiments, the audio or sound is received periodically (e.g., every 1 minute, every 5 minutes, every 30 minutes, every hour, every day etc.) for a certain time period (e.g., 1 week, 24 hours, 12 hours, 6 hours, 1 hour, etc.).

At block 406, the received audio is converted to a digital signal (which may be understood to be a form of audio data). In some embodiments, the converting includes converting the received audio to a waveform (e.g., the waveform 204 discussed in relation to FIG. 2) representing the received audio (e.g., representing the sound made by the machine and any background noise). At block 408, the digital signal is processed. In some embodiments, the processing includes determining whether the digital signal includes machine audio. In some embodiments, the processing includes eliminating background noise other than audio of the machine from the digital signal. In some embodiments, the processing includes applying one or more filters that isolate the portion of the digital signal corresponding to the audio of the machine. In some embodiments, this filtering may include subtracting a digital signal of any ambient audio associated with the capture device/the one or more servers that performs the audio capture (e.g., as may have been captured by the capture device 106 of FIG. 1 and as stored at the block 310 of FIG. 3, or alternatively as dynamically determined) from the digital signal. Then, the processing transforms the digital signal (e.g., perhaps as filtered/modified) into a digital signature. In some embodiments, the digital signature may be a combination of unique letters and/or numbers corresponding to the digital signal.

At a block 410, machine operation and identity is attempted to be determined using the digital signature. In some embodiments, the block 410 includes determining a status of the machine using the digital signature, the status of the machine indicating normal operation of the machine or that operation of the machine is indeterminable. As part of this determination, in some embodiments, the digital signature is compared to one or more other digital signatures stored in a catalog of digital signatures of a memory of a storage system (e.g., of the capture device 106, or the one or more servers 110), where each digital signature corresponds to the sound made by a particular machine during normal operation. If there is a match between the generated digital signature and a digital signal of the catalog (e.g., any difference(s) in values between the generated digital signature and the digital signature of the catalog are below a predetermined threshold), the generated digital signature is determined as being generated by the machine that produced audio from which the digital signal in the catalog was generated. Accordingly, the identity of the machine may be determined. Further, the operation of the machine can also be determined. For example, the capture device 106 and/or the one or more servers 110 may determine that since there is a match between the generated digital signature and a cataloged digital signature reflecting normal operation of the machine, the machine is operating normally.

If there is no match between the processed digital signal and a digital signal of the catalog (e.g., any difference(s) in values between the processed digital signal and each of the digital signals of the catalog are above a predetermined threshold), the processed digital signal is determined as perhaps not belonging to a machine in the catalog for identification purposes, and/or that operation of the (presumed) machine cannot be determined. This may be due to, for example, a malfunction of the machine that creates operation sound that is different to and does not match with signature(s) in the catalog reflecting machine sound made during normal operation of the machine. Alternatively, for example, this may indicate that the machine has completed an operation (or has not started an operation) and is therefore not creating operation sound. In such cases, although normal operation of the machine cannot be determined (due to lack of sound created by the machine), the machine may still be functional and available to operate normally if directed to. In some embodiments, lack of machine operation sound in received sound is identifiable by the capture device 106 if the difference between the received sound and the cataloged digital signal is greater than a threshold.

In some embodiments, the process 400 may also return from the block 410 to the block 402 to provide further training to enhance machine operation and/or identity determination and/or provide training for a new machine. In some embodiments, alternatively in or addition, the process 400 may return from the block 410 to the block 404 to receive more audio of the machine and attempt determining machine operation and identity again in accordance with blocks 404 through 410.

At block 412, a notification may be sent to a user indicating a status, e.g., that normal operation of the machine was determined, or that the status of the machine was indeterminable. In some embodiments, a presence of, or lack of, identifiable machine operation sound may trigger the capture device 106 and/or the one or more servers 110 to send a notification. In some embodiments, a status may indicate a lack of identifiable machine operation sound at the capture device 106 and/or the one or more servers 110. Further, based on this status information, it may be determined due to the lack of identifiable machine operation, a prior machine operation (e.g., washing cycle of a washing machine, coffee making by a coffee maker, and the like) is complete (or has not started), and this information may also be sent in the notification. In such embodiments, the capture device 106/the one or more servers 110 may be configured to perform such a notification and/or make such a determination after previously determining that normal operation of the machine was occurring, in the manner described above. Alternatively, the user may themselves make such a determination based on receiving (only) the status information in a notification.

In some embodiments, the process 400 may then return from the block 412 to the block 404 to receive more audio from the environment of the machine and attempt determining machine operation and identity in accordance with blocks 404 through 410. In some embodiments, alternatively or in addition, the process 400 returns from the block 412 to the block 402 for further training to enhance machine operation and/or provide recognition of a new machine.

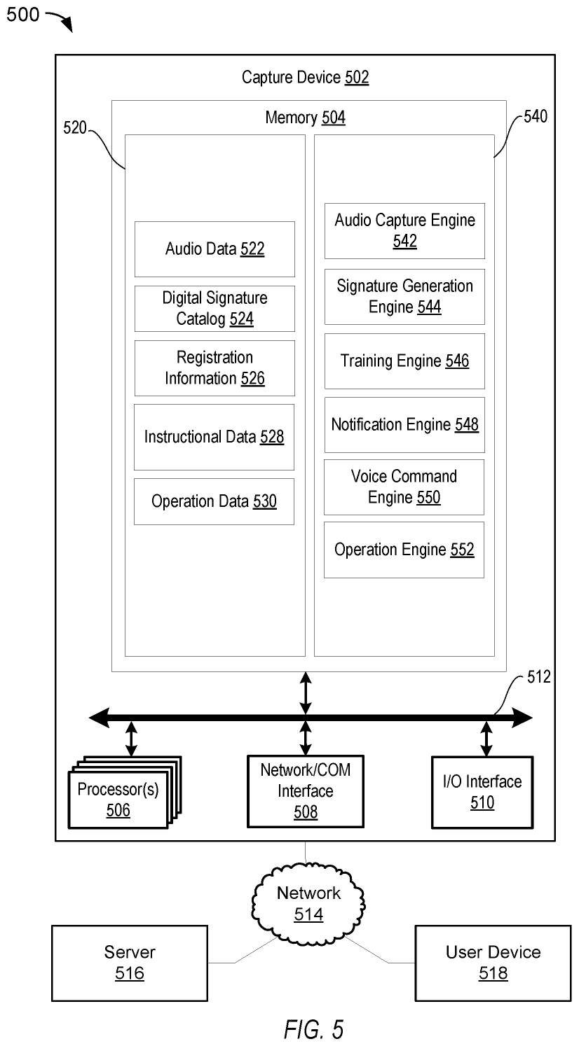

FIG. 5 illustrates a system 500 in accordance with an embodiment of the disclosure. The system 500 includes a capture device 502, a server 516, and a user device 518. FIG. 5 includes a detailed view of the capture device 502.

The capture device 502 may include a memory 504, one or more processor(s) 506, a network/COM interface 508, and an input/output (I/O) interface 510, which may all communicate with each other using a system bus 512.

The memory 504 of the capture device 502 may include a data store 520. The data store 520 may include audio data 522, a digital signature catalog 524, registration information 526, instructional data 528, and operation data 530.

The audio data 522 may include audio data captured or recorded by the capture device 502 (e.g., using one or more microphones of the I/O interface 510 of the capture device 502). The audio data 522 may be stored as one or more waveforms. The audio data 522 may be collected by the capture device 502 as part of a training process. Alternatively or additionally, once the training process is complete, audio data 522 may be collected as part of determining (current) machine operation status.

The digital signature catalog 524 may include one or more digital signatures generated by the capture device 502 using the audio data 522. Alternatively, the one or more digital signatures may have been generated by the server 516 and sent to the capture device 502 over the network 514 for local use at the capture device 502.

The registration information 526 may include, for example, information about a machine that is being monitored by the capture device 502. For example, the registration information 526 may contain correlation information between a monitored machine (as identified in the registration information 526) and one or more digital signatures of the digital signature catalog 524. The registration information 526 may also include voice command inputs associated with the machine. Further, the registration information 526 may contain identifiers for the machine such that information for the machine used at and/or generated by the capture device 502 is identifiable to the capture device 502. Further, the registration information 526 may contain identifiers for the machine for use in notifications sent to the user device 518, such that the user of the user device 518 may recognize the machine to which the notification corresponds. The registration information 526 may contain a list of one or more machines for which this information is stored. In some embodiments, the registration information 526 may be provided to the capture device 502 by the server 516.

The instructional data 528 may include directions provided by the user (e.g., during a training process at the capture device 502) that enable the capture device 502 to correlate a machine (e.g., as represented in the registration information 526) with captured/recorded audio data and any subsequent digital signature generated using that audio data during a training process performed at the capture device 502. In some embodiments, the instructional data 528 may be provided to the capture device 502 by the server 516.

The operation data 530 may include data that is used for operating the features of the capture device 502 that are not more specifically described herein. For example, the operation data 530 may include an operating system for the capture device 502, data detailing the associations between elements of the data store 520 and the engines 540, etc.

The data store 520 may include data generated by the capture device 502, such as by the engines 540 or other modules. The data of the data store 520 may be organized as one or more data structures.

In addition to the data store 520, the memory 504 of the capture device 502 may further include engines 540. The engines 540 may include an audio capture engine 542, a signature generation engine 544, a training engine 546, a notification engine 548, a voice command engine 550, and an operation engine 552.

The audio capture engine 542 may receive, acquire, and/or capture sound made by a machine (e.g., using one or more microphones of the I/O interface 510). The audio capture engine 542 may further record and/or save the captured audio as audio data (e.g., to the audio data 522 and/or to the server 516).

The signature generation engine 544 may generate digital signatures using audio data (e.g., from the audio data 522), such as described in examples provided above. The signature generation engine 544 may store such digital signatures in the digital signature catalog 524 and/or on the server 516.

The training engine 546 may train the capture device 502 using sound to recognize the normal operation of the machine. The training engine 546 receive registration information that identifies the machine and to store that information in the registration information 526 and/or on the server 516. The training engine 546 may use the audio capture engine 542 to capture audio data of a machine. The training engine 546 may process instructional data (verbal, electronic) (e.g., from the instructional data 528) provided by the user that instructs that sound represented in the captured audio data represents or corresponds to a normal operation of the machine. The training engine 546 may instruct the capture device 502 to use the signature generation engine 544 to use the audio data to generate or determine a digital signature associated with the normal operation of the machine (e.g., by using a base set of discrete signals generated using the audio data). The training engine 546 may correlate the digital signature with the machine using the instructional data 528. The training engine 546 may store the digital signature in the digital signature catalog 524 and/or to the server 516, and further to store any correlation data in the registration information 526 and/or to the server 516.

The notification engine 548 may determine whether a notification should be sent to the user device 518. For example, the notification engine 548 may instruct the capture device 502 to use the audio capture engine 542 to obtain audio data representing sound in an environment of the machine. The notification engine 548 may instruct the capture device 502 to use the signature generation engine 544 to generate a digital signature using this audio data. This process may include, for example, filtering background noise from the audio data. The notification engine 548 may compare this digital signature with one or more digital signatures (e.g., from the digital signature catalog 524 or from the server 516) to evaluate whether there is a match, thereby determining a status of the machine (and also identifying the machine). The notification engine 548 may then send a notification to the user device (e.g., via the network 514) that includes the determined status of the machine to the user device 518.

The voice command engine 550 may determine whether audio data (e.g., as captured by the audio capture engine 542, and perhaps stored in the audio data 522) represents a voice command for the capture device 502. Further, the voice command engine 550 may perform one or more actions corresponding to any such identified voice command. Examples of actions corresponding to such voice commands may include, for example, capturing audio to use for training for a particular machine (and performing the corresponding training, which may further include identifying the machine using the captured audio and storing that information in the registration information 526), configuring conditions for notifications to be made by the notification engine 548 to the user device 518 regarding a machine, etc. A voice command for a machine may be identified by the voice command engine 550 by checking against known voice command inputs found in the registration information 526.

The operation engine 552 may perform features of the capture device 502 that are not more specifically described herein. For example, the operation engine 552 may operate an operating system for the capture device 502, transport data on the system bus 512, add/remove data from the data store 520, perform/enable the described communications with the server 516 and/or the user device 518 via the network 514, etc.

The engines 540 may run multiple operations concurrently or in parallel by or on the one or more processor(s) 506. In some embodiments, portions of the disclosed modules, components, and/or facilities are embodied as executable instructions stored in hardware or in firmware, or stored on a non-transitory, machine-readable storage medium. The instructions may comprise computer code that, when executed by the one or more processor(s) 506, cause the capture device 502 to implement certain processing steps, procedures, and/or operations, as disclosed herein.

The functions of the capture device 502 have been discussed in terms of engines 540 in the memory 504, which is a description that is given by example and not by way of limitation. Persons having ordinary skill in the art will recognize that any of the engines 540 may operate using any elements (either alone or in combination) of the capture device 502, including (but not limited to) the memory 504, the processor(s) 506, the network/COM interface 508, the I/O interface 510, and the system bus 512. Further, persons having ordinary skill in the art will recognize that the engines 540 may operate using other elements not shown herein (e.g., a custom computer chip with firmware to operate all or part of one or more of the engines 540). Further, it is contemplated that the engines 540 may include additional functionality other than what has been described.

The memory 504 of the capture device 502 may store data in a static manner. For example, the memory 504 may comprise, e.g., a hard disk capable of storing data even during times when the capture device 502 is not powered on. The memory 504 may also store data in a dynamic manner. For example, the memory 504 may comprise Random Access Memory (RAM) storage configured to hold engines (including engines 540). The memory 504 may include static RAM, dynamic RAM, flash memory, one or more flip-flops, ROM, CD-ROM, DVD, disk, tape, or magnetic, optical, or other computer storage medium, including at least one non-volatile storage medium. The memory 504 is capable of storing machine-readable and -executable instructions that the one or more processor(s) 506 are capable of reading and executing. The memory 504 may be local to the capture device 502 and may comprise a memory module or subsystem remote from capture device 502 and/or distributed over a network (including the network 514).

The one or more processor(s) 506 of the capture device 502 may perform the functionalities already described herein. In addition, the processors 506 may perform other system control tasks, such as controlling data flows on the system bus 512 between the memory 504, the network/COM interface 508, and the I/O interface 510. The details of these (and other) background operations may be defined in operating system instructions (not shown) upon which the one or more processor(s) 506 operate.

The one or more processor(s) 506 may include one or more general purpose devices, such as an Intel®, AMD®, or other standard microprocessor, and/or a special purpose processing device, such as ASIC, SoC, SiP, FPGA, PAL, PLA, FPLA, PLD, or other customized or programmable device. The one or more processor(s) 506 may perform distributed (e.g., parallel) processing to execute or otherwise implement functionalities of the present embodiments. The one or more processor(s) 506 may run a standard operating system and perform standard operating system functions.

The network/COM interface 508 of the capture device 502 may be connected to a network 514 and may act as a reception and/or distribution device for computer-readable instructions. This connection may facilitate the transfer of information (e.g., computer-readable instructions) from the capture device 502 to and from the server 516. The network/COM interface 508 may facilitate communication with other computing devices and/or networks, such as the Internet and/or other computing and/or communications networks. The network/COM interface 508 may be equipped with conventional network connectivity, such as, for example, Ethernet (IEEE 502.3), Token Ring (IEEE 502.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The I/O interface 510 may comprise any mechanism allowing an operator to interact with and/or provide data to the capture device 502. For example, the I/O interface 510 may include one or more microphones for capturing/recording sound, in the manner described above. Further, the I/O interface 510 may include a keyboard, a mouse, a monitor, and/or a data transfer mechanism, such as a disk drive or a flash memory drive. The I/O interface 510 may allow an operator to place information in the memory 504, or to issue instructions to the capture device 502 to perform any of the functions described herein.

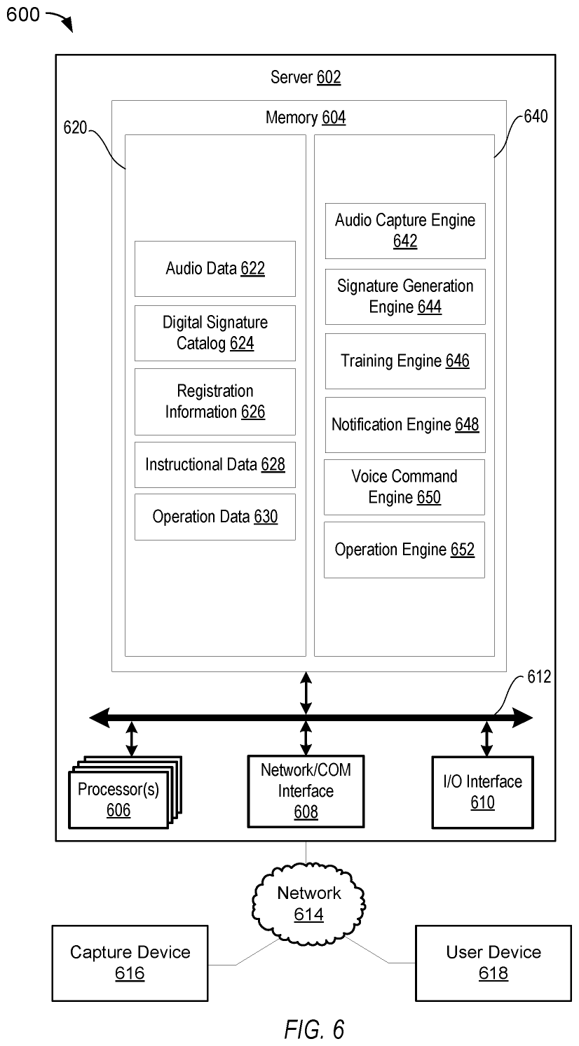

FIG. 6 illustrates a system 600 in accordance with one embodiment of the present disclosure. The system 600 includes a server 602 and a capture device 616. FIG. 6 includes a detailed view of the server 602. As will be described, the server 602 may be capable of many of the functions that may be associated with a capture device (such as a capture device 502 of FIG. 5). Alternatively or additionally, the server 602 may have data and engines configured to support functionalities of some embodiments of, e.g., a capture device such as the capture device 502 of FIG. 5, as will also be described.

The server 602 may include a memory 604, one or more processor(s) 606, a network/COM interface 608, and an input/output (I/O) interface 610, which may all communicate with each other using a system bus 612.

The memory 604 of the server 602 may include a data store 620. The data store 620 may include audio data 622, a digital signature catalog 624, registration information 626, instructional data 628, and operation data 630.

The audio data 622 may include audio data captured or recorded by the capture device 616 (e.g., using one or more microphones of the I/O interface 610 of the capture device 616) and subsequently sent to the server 602. The audio data 622 may be stored as one or more waveforms. The audio data 622 may be collected by the capture device 616 and sent to the server 602 as part of a training process. Alternatively or additionally, once the training process is complete, audio data 622 may be collected as part of determining (current) machine operation status. Additionally or alternatively, the server 602 may itself perform the collection of the audio data 622 (e.g., using one or more microphones of the I/O interface 610 of the server 602) attendant to training and/or determining (current) machine operation status.

The digital signature catalog 624 may include one or more digital signatures generated by the capture device 616 and that was sent to the server 602 for later use within the system 600. Additionally or alternatively, the digital signature catalog 624 may include one or more digital signatures generated by the server 602 (e.g., using the audio data 622).

The registration information 626 may include, for example, information about a machine that is being monitored by the capture device 616 or the server 602. For example, the registration information 626 may contain correlation information between a monitored machine (as identified in the registration information 626) and one or more digital signatures of the digital signature catalog 624. The registration information 626 may also include voice command inputs associated with the machine. Further, the registration information 626 may contain identifiers for a machine such that information for the machine used at and/or generated by the capture device 616 or the server 602 is identifiable to the capture device 616 or the server 602. Further, the registration information 626 may contain identifiers for the machine for use in notifications sent to the user device 618, such that the user of the user device 618 may recognize the machine to which the notification corresponds. The registration information 626 may contain a list of one or more machines for which this information is stored. The registration information 626 may be generated by the capture device 616 and provided to the server 602 by the capture device 616 for storage. In other embodiments, the server 602 itself sources the registration information (e.g., via communication with the user device 618 over the network 614). If the registration information 626 is needed at the capture device 616, it may be sent from the server 602 to the capture device 616.

The instructional data 628 may include directions provided by the user (e.g., during a training process at the capture device 616, or alternatively at the server 602, perhaps via the user device 618) that enable the server 602 to correlate a machine (e.g., as represented in the registration information 626) with captured/recorded audio data and any subsequent digital signature generated using that audio data during a training process performed using the server 602. The instructional data 628 may have been provided to the server 602 by the capture device 616. If the instructional data 628 is needed at the capture device 616, it may be sent from the server 602 to the capture device 616.

The operation data 630 may include data that is used for operating the features of the server 602 that are not more specifically described herein. For example, the operation data 630 may include an operating system for the server 602, data detailing the associations between elements of the data store 620 and the engines 640, etc.

The data store 620 may include data generated by the server 602, such as by the engines 640 or other modules. The data of the data store 620 may be organized as one or more data structures.

In addition to the data store 620, the memory 604 of the server 602 may further include engines 640. The engines 640 may include an audio capture engine 642, a signature generation engine 644, a training engine 646, a notification engine 648, a voice command engine 650, and an operation engine 652.

The audio capture engine 642 may receive, acquire, and/or capture sound made by a machine (e.g., using one or more microphones of the I/O interface 610). The audio capture engine 642 may further record and/or save the captured audio as audio data (e.g., to the audio data 622).

The signature generation engine 644 may generate digital signatures using audio data (e.g., from the audio data 622), consistent with examples provided above. The signature generation engine 644 may store such digital signatures in the digital signature catalog 624. Further, the signature generation engine 644 may be capable of sending signatures to the capture device 616 for local use at the capture device 616.

The training engine 646 may train using sound to recognize the normal operation of the machine. The training engine 646 may receive registration information that identifies the machine and to store that information in the registration information 626. The training engine 646 may use the audio capture engine 642 to capture audio data of a machine. The training engine 646 may process instructional data (verbal, electronic) (e.g., from the instructional data 628) provided by the user that instructs that sound represented in the captured audio data represents or corresponds to a normal operation of the machine. The training engine 646 may instruct the server 602 to use the signature generation engine 644 to use the audio data to generate or determine a digital signature associated with the normal operation of the machine (e.g., by using a base set of discrete signals generated using the audio data). The training engine 646 may correlate the digital signature with the machine using the instructional data 628. The training engine 646 may store the digital signature in the digital signature catalog 624, and further to store any correlation data in the registration information 626.

The notification engine 648 may determine whether a notification should be sent to the user device 618. For example, the notification engine 648 may instruct the server 602 obtain audio data representing sound in an environment of the machine. This audio data may be (ultimately) obtained from, for example, the capture device 616 (e.g., be sent to the server 602 using over the network 614 by the capture device 616). Alternatively, a server 602 may use the audio capture engine 642 to itself source the audio data. The notification engine 648 may instruct the server 602 to use the signature generation engine 644 to generate a digital signature using this audio data. This process may include, for example, filtering background noise from the audio data. The notification engine 648 may compare this digital signature with one or more digital signatures (e.g., from the digital signature catalog 624) to evaluate whether there is a match, thereby determining a status of the machine (and also identifying the machine). The notification engine 648 may then send a notification to the user device (e.g., via the network 614) that includes the determined status of the machine to the user device 618.

The voice command engine 650 may determine whether audio data (e.g., as provided from the capture device 616, or perhaps as captured by the audio capture engine 642, and perhaps stored in the audio data 622) represents a voice command for the server 602. Further, the voice command engine 650 may perform one or more actions corresponding to any such identified voice command. Examples of actions corresponding to such voice commands may include, for example, instructing the capture device 616 to capture audio to use for training for a particular machine and provide it to the server 602 (and performing the corresponding training, which may further include identifying the machine using the captured audio and storing that information in the registration information 626), configuring conditions for notifications to be made by the notification engine 648 to the user device 618 regarding a machine, etc. A voice command for a machine may be identified by the voice command engine 650 by checking against known voice command inputs found in the registration information 626.

The operation engine 652 may perform features of the server 602 that are not more specifically described herein. For example, the operation engine 652 may operate an operating system for the server 602, transport data on the system bus 612, add/remove data from the data store 620, perform/enable the described communications with the capture device 616 and/or the user device 618 via the network 614, etc.

The engines 640 may run multiple operations concurrently or in parallel by or on the one or more processor(s) 606. In some embodiments, portions of the disclosed modules, components, and/or facilities are embodied as executable instructions stored in hardware or in firmware, or stored on a non-transitory, machine-readable storage medium. The instructions may comprise computer code that, when executed by the one or more processor(s) 606, cause the server 602 to implement certain processing steps, procedures, and/or operations, as disclosed herein.

The functions of the server 602 have been discussed in terms of engines 640 in the memory 604, which is a description that is given by example and not by way of limitation. Persons having ordinary skill in the art will recognize that any of the engines 640 may operate using any elements (either alone or in combination) of the server 602, including (but not limited to) the memory 604, the processor(s) 606, the network/COM interface 608, the I/O interface 610, and the system bus 612. Further, persons having ordinary skill in the art will recognize that the engines 640 may operate using other elements not shown herein (e.g., a custom computer chip with firmware to operate all or part of one or more of the engines 640). Further, it is contemplated that the engines 640 may include additional functionality other than what has been described.

The memory 604 of the server 602 may store data in a static manner. For example, the memory 604 may comprise, e.g., a hard disk capable of storing data even during times when the server 602 is not powered on. The memory 604 may also store data in a dynamic manner. For example, the memory 604 may comprise Random Access Memory (RAM) storage configured to hold engines (including engines 640). The memory 604 may include static RAM, dynamic RAM, flash memory, one or more flip-flops, ROM, CD-ROM, DVD, disk, tape, or magnetic, optical, or other computer storage medium, including at least one non-volatile storage medium. The memory 604 is capable of storing machine-readable and -executable instructions that the one or more processor(s) 606 are capable of reading and executing. The memory 604 may be local to the server 602 and may comprise a memory module or subsystem remote from server 602 and/or distributed over a network (including the network 614).

The one or more processor(s) 606 of the server 602 may perform the functionalities already described herein. In addition, the processors 606 may perform other system control tasks, such as controlling data flows on the system bus 612 between the memory 604, the network/COM interface 608, and the I/O interface 610. The details of these (and other) background operations may be defined in operating system instructions (not shown) upon which the one or more processor(s) 606 operate.

The one or more processor(s) 606 may include one or more general purpose devices, such as an Intel®, AMD®, or other standard microprocessor; and/or a special purpose processing device, such as ASIC, SoC, SiP, FPGA, PAL, PLA, FPLA, PLD, or other customized or programmable device. The one or more processor(s) 606 may perform distributed (e.g., parallel) processing to execute or otherwise implement functionalities of the present embodiments. The one or more processor(s) 606 may run a standard operating system and perform standard operating system functions.

The network/COM interface 608 of the server 602 may be connected to a network 614 and may act as a reception and/or distribution device for computer-readable instructions. This connection may facilitate the transfer of information (e.g., computer-readable instructions) from the server 602 to and from the capture device 616. The network/COM interface 608 may facilitate communication with other computing devices and/or networks, such as the Internet and/or other computing and/or communications networks. The network/COM interface 608 may be equipped with conventional network connectivity, such as, for example, Ethernet (IEEE 602.3), Token Ring (IEEE 602.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The I/O interface 610 may comprise any mechanism allowing an operator to interact with and/or provide data to the server 602. For example, the I/O interface 610 may include one or more microphones for capturing/recording sound, in the manner described above. Further, the I/O interface 610 may include a keyboard, a mouse, a monitor, and/or a data transfer mechanism, such as a disk drive or a flash memory drive. The I/O interface 610 may allow an operator to place information in the memory 604, or to issue instructions to the server 602 to perform any of the functions described herein.

### EXAMPLES

The following are some examples according to systems and methods disclosed herein. In order to avoid complexity in providing the disclosure, not all of the examples listed below are separately and explicitly disclosed as combinable with each other example listed below and/or embodiment disclosed hereinabove with which they are actually combinable. However, unless one of ordinary skill in the art would understand that an example is not actually combinable with another given example and/or embodiment, it is contemplated to be within the scope of the disclosure that the example can be combined with the other examples and/or embodiments described herein.

Example 1. An apparatus for training to determine machine operation, comprising: a processor; a memory storing instructions that, when executed by the processor, configure the apparatus to: register a machine in a database using registration information to create a machine registration in the database (e.g., the registration information indicating a type of the machine); obtain audio data of the machine, the audio data representing sound made by the machine during a normal operation of the machine; generate a base set of discrete signals using the audio data; determine a digital signature associated with the normal operation of the machine using the base set of discrete signals; receive instructional data to correlate the digital signature with the machine (e.g., the instructional data indicating that the digital signature reflects the normal operation of the machine); and correlate the digital signature with the machine registration using the instructional data.

Example 2. The apparatus of Example 1, wherein: the apparatus further comprises one or more microphones; and the instructions, when executed by the processor, further configure the apparatus to: receive the sound made by the machine during the normal operation of the machine using the one or more microphones; and generate the audio data using the sound made by the machine during the normal operation of the machine.

Example 3. The apparatus of Example 1, wherein the audio data is obtained via a network.

Example 4. The apparatus of Example 1, wherein the audio data comprises a waveform.

Example 5. The apparatus of Example 1, wherein the audio data comprises a plurality of digital signals representing the sound made by the machine during the normal operation of the machine.

Example 6. The apparatus of Example 1, wherein the instructions, when executed by the processor, further configure the apparatus to send the digital signature to a server.

Example 7. The apparatus of Example 1, wherein the registration information is received via a voice command from a user.

Example 8. The apparatus of Example 1, wherein the instructions, when executed by the processor, further configure the apparatus to generate the base set of discrete signals using the audio data by filtering ambient audio data from the audio data.

Example 9. The apparatus of Example 1, wherein the instructions, when executed by the processor, further configure the apparatus to generate the base set of discrete signals using the audio data by removing excursions from an initial set of discrete signals generated using the audio data.

Example 10. The apparatus of Example 1, wherein the instructional data is received via a voice command from a user.

Example 11. The apparatus of Example 1, wherein the apparatus comprises an electric vehicle supply equipment (EVSE).

Example 12. A method of a device for training to determine machine operation, comprising: registering a machine in a database using registration information to create a machine registration in the database; obtaining audio data of the machine, the audio data representing sound made by the machine during a normal operation of the machine; generating a base set of discrete signals using the audio data; determining a digital signature associated with the normal operation of the machine using the base set of discrete signals; receiving instructional data to correlate the digital signature with the machine; and correlating the digital signature with the machine registration using the instructional data.

Example 13. The method of Example 12, further comprising: receiving the sound made by the machine during the normal operation of the machine; and generating the audio data using the sound made by the machine during the normal operation of the machine.

Example 14. The method of Example 12, wherein the audio data is obtained via a network.

Example 15. The method of Example 12, wherein the audio data comprises a waveform.

Example 16. The method of Example 12, wherein the audio data comprises a plurality of digital signals representing the sound made by the machine during the normal operation of the machine.

Example 17. The method of Example 12, further comprising sending the digital signature to a server.

Example 18. The method of Example 12, wherein the registration information is received via a voice command from a user.

Example 19. The method of Example 12, wherein generating the base set of discrete signals using the audio data comprises filtering ambient audio data from the audio data.

Example 20. The method of Example 12, wherein generating the base set of discrete signals using the audio data comprises removing excursions from an initial set of discrete signals generated using the audio data.

Example 21. The method of Example 12, wherein the instructional data is received via a voice command from a user.

Example 22. The method of Example 12, wherein the device comprises an electric vehicle supply equipment (EVSE).

Example 23. A non-transitory computer-readable storage medium comprising instructions that when executed by a device, cause the device to: register a machine in a database using registration information to create a machine registration in the database; obtain audio data of the machine, the audio data representing sound made by the machine during a normal operation of the machine; generate a base set of discrete signals using the audio data; determine a digital signature associated with the normal operation of the machine using the base set of discrete signals; receive instructional data to correlate the digital signature with the machine; and correlate the digital signature with the machine registration using the instructional data.

Example 24. The non-transitory computer-readable storage medium of Example 23, wherein: the device further comprises one or more microphones; and the instructions, when executed by the device, further cause the device to: receive the sound made by the machine during the normal operation of the machine using the one or more microphones; and generate the audio data using the sound made by the machine during the normal operation of the machine.

Example 25. The non-transitory computer-readable storage medium of Example 23, wherein the audio data is obtained via a network.

Example 26. The non-transitory computer-readable storage medium of Example 23, wherein the audio data comprises a waveform.

Example 27. The non-transitory computer-readable storage medium of Example 23, wherein the audio data comprises a plurality of digital signals representing the sound made by the machine during the normal operation of the machine.

Example 28. The non-transitory computer-readable storage medium of Example 23, wherein the instructions, when executed by the device, further cause the device to send the digital signature to a server.

Example 29. The non-transitory computer-readable storage medium of Example 23, wherein the registration information is received via a voice command from a user.

Example 30. The non-transitory computer-readable storage medium of Example 23, wherein the instructions, when executed by the device, further cause the device to generate the base set of discrete signals using the audio data by filtering ambient audio data from the audio data.

Example 31. The non-transitory computer-readable storage medium of Example 23, wherein the instructions, when executed by the device, further cause the device to generate the base set of discrete signals using the audio data by removing excursions from an initial set of discrete signals generated using the audio data.

Example 32. The non-transitory computer-readable storage medium of Example 23, wherein the instructional data is received via a voice command from a user.

Example 33. The non-transitory computer-readable storage medium of Example 23, wherein the device comprises an electric vehicle supply equipment (EVSE).

Example 34. An apparatus for determining machine operation, the apparatus comprising: a processor; a memory storing instructions that, when executed by the processor, configure the apparatus to: obtain audio data representing sound present in an environment of a machine; determine a first digital signature using the audio data; determine a status of the machine using the first digital signature and a second digital signature associated with a normal operation of the machine, the status indicating one of that an operation of the machine comprises the normal operation of the machine and that the operation of the machine is indeterminable; and transmit a notification including the status of the machine to a user device.

Example 35. The apparatus of Example 34, wherein: the apparatus further comprises one or more microphones; and the instructions, when executed by the processor, further configure the apparatus to: receive the sound present in the environment of the machine using the one or more microphones; and generate the audio data using the sound present in the environment of the machine.

Example 36. The apparatus of Example 35, wherein the instructions, when executed by the processor, further configure the apparatus to receive the sound present in the environment of the machine according to a periodic schedule configured at the apparatus.

Example 37. The apparatus of Example 34, wherein the instructions, when executed by the processor, further configure the apparatus to obtain the audio data via a network.

Example 38. The apparatus of Example 34, wherein the audio data comprises a waveform.

Example 39. The apparatus of Example 34, wherein the instructions, when executed by the processor, further configure the apparatus to trigger transmission of the notification in response to determining the status.

Example 40. The apparatus of Example 34, wherein the instructions, when executed by the processor, further configure the apparatus to receive the second digital signature from a server.

Example 41. The apparatus of Example 34, wherein: the memory further comprises a catalog of stored digital signatures; and the instructions, when executed by the processor, further configure the apparatus to locate the second digital signature out of the catalog of stored digital signatures.

Example 42. The apparatus of Example 34, wherein the instructions, when executed by the processor, further configure the apparatus to determine the first digital signature using the audio data by filtering ambient audio data from the audio data.

Example 43. The apparatus of Example 34, wherein the instructions, when executed by the processor, further configure the apparatus to determine the status of the machine using the first digital signature and the second digital signature by: determining a difference in value between the first digital signature and the second digital signature; and comparing the difference in value to a threshold.

Example 44. The apparatus of Example 34, wherein the instructions, when executed by the processor, further configure the apparatus to obtain second audio data of the machine representing second sound present in the environment of the machine after transmitting the notification.

Example 45. The apparatus of Example 34, wherein the user device comprises a mobile phone.

Example 46. The apparatus of Example 34, wherein the apparatus comprises an electric vehicle supply equipment (EVSE).

Example 47. A method of a device for determining machine operation comprising: obtaining audio data representing sound present in an environment of a machine; determining a first digital signature using the audio data; determining a status of the machine using the first digital signature and a second digital signature associated with a normal operation of the machine, the status indicating one of that an operation of the machine comprises the normal operation of the machine and that the operation of the machine is indeterminable; and transmitting a notification including the status of the machine to a user device.

Example 48. The method of Example 47, further comprising:

receiving the sound present in the environment of the machine using one or more microphones; and generating the audio data using the sound present in the environment of the machine.

Example 49. The method of Example 48, wherein the sound present in the environment of the machine is received according to a periodic schedule configured at the device.

Example 50. The method of Example 47, wherein the audio data is obtained via a network.

Example 51. The method of Example 37, wherein the audio data comprises a waveform.

Example 52. The method of Example 47, further comprising triggering transmission of the notification in response to determining the status.

Example 53. The method of Example 47, wherein the second digital signature is received from a server.

Example 54. The method of Example 47, wherein the second digital signature is located out of a catalog of stored digital signatures on the device.

Example 55. The method of Example 47, wherein determining the first digital signature using the audio data comprises filtering ambient audio data from the audio data.

Example 56. The method of Example 47, wherein determining the status of the machine using the first digital signature and the second digital signature comprises: determining a difference in value between the first digital signature and the second digital signature; and comparing the difference in value to a threshold.

Example 57. The method of Example 47, further comprising obtaining second audio data of the machine representing second sound present in the environment of the machine after transmitting the notification.

Example 58. The method of Example 47, wherein the user device comprises a mobile phone.

Example 59. The method of Example 47, wherein the device comprises an electric vehicle supply equipment (EVSE).

Example 60. A non-transitory computer-readable storage medium, the computer-readable storage medium including instructions that when executed by a device, cause the device to: obtain audio data representing sound present in an environment of a machine; determine a first digital signature using the audio data; determine a status of the machine using the first digital signature and a second digital signature associated with a normal operation of the machine, the status indicating one of that an operation of the machine comprises the normal operation of the machine and that the operation of the machine is indeterminable; and transmit a notification including the status of the machine to a user device.

Example 61. The non-transitory computer-readable storage medium of Example 60, wherein: the device further comprises one or more microphones; and the instructions, when executed by the device, further cause the device to: receive the sound present in the environment of the machine using the one or more microphones; and generate the audio data using the sound present in the environment of the machine.

Example 62. The non-transitory computer-readable storage medium of Example 61, wherein the instructions, when executed by the device, further cause the device to receive the sound present in the environment of the machine according to a periodic schedule configured at the apparatus.

Example 63. The non-transitory computer-readable storage medium of Example 60, wherein the instructions, when executed by the device, further cause the device to obtain the audio data via a network.

Example 64. The non-transitory computer-readable storage medium of Example 60, wherein the audio data comprises a waveform.

Example 65. The non-transitory computer-readable storage medium of Example 60, wherein the instructions, when executed by the device, further cause the device to trigger transmission of the notification in response to determining the status.

Example 66. The non-transitory computer-readable storage medium of Example 60, wherein the instructions, when executed by the device, further cause the device to receive the second digital signature from a server.

Example 67. The non-transitory computer-readable storage medium of Example 60, wherein: the memory further comprises a catalog of stored digital signatures; and the instructions, when executed by the device, further cause the device to locate the second digital signature out of the catalog of stored digital signatures.

Example 68. The non-transitory computer-readable storage medium of Example 60, wherein the instructions, when executed by the device, further cause the device to determine the first digital signature using the audio data by filtering ambient audio data from the audio data.

Example 69. The non-transitory computer-readable storage medium of Example 60, wherein the instructions, when executed by the device, further cause the device to determine the status of the machine using the first digital signature and the second digital signature by: determining a difference in value between the first digital signature and the second digital signature; and comparing the difference in value to a threshold.

Example 70. The non-transitory computer-readable storage medium of Example 60, wherein the instructions, when executed by the device, further cause the device to obtain second audio data of the machine representing second sound present in the environment of the machine after transmitting the notification.

Example 71. The non-transitory computer-readable storage medium of Example 60, wherein the user device comprises a mobile phone.

Example 72. The non-transitory computer-readable storage medium of Example 60, wherein the device comprises an electric vehicle supply equipment (EVSE).

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Descriptions is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

At least some embodiments may comprise a computer program product including a computer-readable storage medium having stored instructions and/or data thereon that may be used to program a computer (or other electronic device) to perform processes described herein. The computer-readable storage medium comprises at least a non-transient storage medium, such as, e.g., a hard drive, a fixed disk, a removable disk, a floppy diskette, an optical disk, a CD-ROM, a CD-RW, a DVD-ROM, a DVD-RW, a read-only memory (ROM), a random access memory (RAM), an erasable programmable ROM (EPROM), an electrically erasable programmable ROM (EEPROM), a magnetic card, an optical card, a solid-state memory device, or other types of media/machine-readable media suitable for storing electronic instructions and/or data.

It is recognized that any standard operating systems may be used may be used on devices disclosed herein (e.g., in conjunctions with the hardware of such devices), such as, for example, Microsoft® Windows®, Apple® MacOS®, Disk Operating System (DOS), UNIX, IRJX, Solaris® SunOS®, FreeBSD, Linux®, ffiM® OS/2® operating systems, and so forth.

A software module, module, or component may include any type of computer instruction or computer executable code located within a memory device and/or computer-readable storage medium, as is well-known in the art.

The modules, components, and/or facilities disclosed herein may be implemented and/or embodied as a driver, a library, an interface, and API, FPGA configuration data, firmware (e.g., stored on an EEPROM or similar device), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGA(s), ASIC(s), and/or the like.

It will be obvious to those having skill in the art that many changes may be made to the details of the above described embodiments without departing from the underlying principles of the invention. The scope of the present invention should, therefore, be determined only by the following claims.

1. An apparatus for training to determine machine operation, comprising:
a processor;
a memory storing instructions that, when executed by the processor, configure the apparatus to:
register a machine in a database using registration information to create a machine registration in the database;
obtain audio data of the machine, the audio data representing sound made by the machine during a normal operation of the machine;
generate a base set of discrete signals using the audio data;
determine a digital signature associated with the normal operation of the machine using the base set of discrete signals;
receive instructional data to correlate the digital signature with the machine; and
correlate the digital signature with the machine registration using the instructional data.

2. The apparatus of claim 1, wherein:
the apparatus further comprises one or more microphones; and
the instructions, when executed by the processor, further configure the apparatus to:
receive the sound made by the machine during the normal operation of the machine using the one or more microphones; and
generate the audio data using the sound made by the machine during the normal operation of the machine.

3. The apparatus of claim 1, wherein the audio data is obtained via a network.

4. The apparatus of claim 1, wherein the audio data comprises a waveform.

5. The apparatus of claim 1, wherein the audio data comprises a plurality of digital signals representing the sound made by the machine during the normal operation of the machine.

6. The apparatus of claim 1, wherein the instructions, when executed by the processor, further configure the apparatus to send the digital signature to a server.

7. The apparatus of claim 1, wherein the registration information is received via a voice command from a user.

8. The apparatus of claim 1, wherein the instructions, when executed by the processor, further configure the apparatus to generate the base set of discrete signals using the audio data by filtering ambient audio data from the audio data.

9. The apparatus of claim 1, wherein the instructions, when executed by the processor, further configure the apparatus to generate the base set of discrete signals using the audio data by removing excursions from an initial set of discrete signals generated using the audio data.

10. The apparatus of claim 1, wherein the instructional data is received via a voice command from a user.

11. The apparatus of claim 1, wherein the apparatus comprises an electric vehicle supply equipment (EVSE).

12. A method of a device for training to determine machine operation, comprising:
registering a machine in a database using registration information to create a machine registration in the database;
obtaining audio data of the machine, the audio data representing sound made by the machine during a normal operation of the machine;
generating a base set of discrete signals using the audio data;
determining a digital signature associated with the normal operation of the machine using the base set of discrete signals;
receiving instructional data to correlate the digital signature with the machine; and
correlating the digital signature with the machine registration using the instructional data.

13. The method of claim 12, further comprising:
receiving the sound made by the machine during the normal operation of the machine; and
generating the audio data using the sound made by the machine during the normal operation of the machine.

14. The method of claim 12, wherein the audio data is obtained via a network.

15. The method of claim 12, wherein the audio data comprises a waveform.

16. The method of claim 12, wherein the audio data comprises a plurality of digital signals representing the sound made by the machine during the normal operation of the machine.

17. The method of claim 12, further comprising sending the digital signature to a server.

18. The method of claim 12, wherein the registration information is received via a voice command from a user.

19. The method of claim 12, wherein generating the base set of discrete signals using the audio data comprises filtering ambient audio data from the audio data.

20. The method of claim 12, wherein generating the base set of discrete signals using the audio data comprises removing excursions from an initial set of discrete signals generated using the audio data.

21. The method of claim 12, wherein the instructional data is received via a voice command from a user.

22. The method of claim 12, wherein the device comprises an electric vehicle supply equipment (EVSE).

23. A non-transitory computer-readable storage medium comprising instructions that when executed by a device, cause the device to:
register a machine in a database using registration information to create a machine registration in the database;
obtain audio data of the machine, the audio data representing sound made by the machine during a normal operation of the machine;
generate a base set of discrete signals using the audio data;
determine a digital signature associated with the normal operation of the machine using the base set of discrete signals;
receive instructional data to correlate the digital signature with the machine; and
correlate the digital signature with the machine registration using the instructional data.
